(19) United States
(12) Patent Application Publication
(10) Pub. No.: US 2018/0222062 A1
(43) Pub. Date: Aug. 9, 2018

(54) Robotic positioning system

(71) Applicant: Peak Analysis and Automation Limited, Farnborough (GB)

(72) Inventors: Rob Harkness, Farnborough (GB); Jon Newman-Smith, Farnborough (GB); Matthew Morgan, Farnborough (GB); Mark Bagnall, Worthen (GB)

(21) Appl. No.: 15/886,921

(22) Filed: Feb. 2, 2018

(30) Foreign Application Priority Data
Feb. 2, 2017 (GB) 1701752.6

(51) Int. Cl. B25J 18/00; B25J 11/00; B25J 15/00

(52) U.S. Cl. CPC B25J 18/007; B25J 15/0028; B25J 11/00

(57) ABSTRACT

A microplate handling apparatus comprising: a base; and a robotic arm mounted on the base; wherein the base has at least one attachment mechanism for attaching a microplate storage device to the base; and wherein the base has at least one instrument alignment mechanism for defining a positional relationship between the robotic arm and an instrument. By providing for attachment of one or more microplate storage devices and one or more instruments to the base, the positional relationships between the robot and the microplate handling/storing devices (i.e. the microplate storage devices and the instruments) can be well-defined without having to secure any of the components (base, microplate storage devices or instruments) to a bench. The whole system can simply sit on top of a bench without any risk of relative movement between the various parts of the system. Instead the whole system is connected together and can be moved as one unit.

The invention relates to robotic arms and positioning systems, particularly in desktop laboratory automation environments such as for moving and handling ANSI/SLAS-1 microplates.

In such systems, microplates (typically 96 well, 384 well or 1536 well plates) are processed by a machine (there are many different such machines, each performing different sample preparation or analysis activities). A machine can typically only operate on a single microplate at a time, but it is desirable to process a large number of microplates in sequence. In order to save laboratory technician time, automation systems are designed with a robotic arm to move microplates between different processing stations, e.g. between microplate storage devices and one or more processing machines. By storing a large number of microplates in the storage device(s), a robotic arm can load and remove the microplates from the machine as required without supervision, thus allowing long processing runs to take place without technician input.

In such systems, it is very important for the robot to be able to pick up and place each microplate accurately. Mis-handling of microplates can result in errors which can halt a whole processing run, causing major losses of time and efficiency. Additionally, mis-handling of microplates can result in spillage of hazardous substances resulting in time-consuming clean-up operations. In order to ensure accurate picking up and depositing of the microplates, the robotic arm must be able to place its grabber with high accuracy with respect to the pick-up and deposit locations. As the microplate stores and processing machines are separate pieces of equipment with no defined relationship, the robotic arm has needed to be provided with a great range of adjustability, i.e. many degrees of freedom (typically 4 or more degrees of freedom, often 6 degrees of freedom) and with high precision control so that it can accurately pick and drop microplates at multiple locations.

These locations are typically programmed in to the robot during a setup stage after all the relative positions have been fixed within the laboratory environment. This is generally a fairly complex setup process and is therefore normally performed by a robotics engineer, adding to the cost and difficulty of setting up such a system.

To prevent relative movement of the various pieces of equipment (robot, microplate stacks, analysis instrument, etc.) after the initial setup, each piece of equipment is fixed in place in some manner. In bench top systems this is often done either by providing appropriately sized cups which are screwed to the bench top and into which the instrument feet are securely located, or by providing raised L-shaped corner pieces into and against which a suitable corner of the equipment is pushed such that it rests within the corner piece, abutting both inner walls of the corner. Multiple such corners (or a combination of corners and cups) can be used for increased accuracy of location fixing.

The requirement of many such positional fixing systems to fix directly to the bench (requiring drilling holes in the bench) is not ideal for many small laboratories, especially where setups may need to be changed frequently, e.g. for different experiments and different processing techniques, e.g. different instruments. Each instrument presents its microplate holder in a different position relative to its own boundaries and instruments are not of consistent shapes and sizes. Therefore the positional fixings for one instrument will generally not be suitable for another instrument and the robot's positional programming for one instrument will be different to that of another instrument.

The cost and complexity of such systems makes them prohibitively expensive for many small laboratory setups which reduces the efficiency and processing capacity of such setups.

According to the invention there is provided a microplate handling apparatus comprising: a base; and a robotic arm mounted on the base; wherein the base has at least one attachment mechanism for attaching a microplate storage device to the base; and wherein the base has at least one instrument alignment mechanism for defining a positional relationship between the robotic arm and an instrument.

By providing for attachment of one or more microplate storage devices and one or more instruments to the base, the positional relationships between the robot and the microplate handling/storing devices (i.e. the microplate storage devices and the instruments) can be well-defined without having to secure any of the components (base, microplate storage devices or instruments) to a bench. The whole system can simply sit on top of a bench without any risk of relative movement between the various parts of the system. Instead the whole system is connected together and can be moved as one unit.

Moreover, as the relative positions of the various components are well-defined, the robot can more easily discover and/or learn each of the positions at which microplates are to be picked up and deposited. Indeed, these positional relationships may already be defined by the attachment mechanism and the alignment mechanism to the extent that the robot does not need to be programmed with each microplate position. Instead, this information may be pre-programmed into the robot so that the set up process for the robot is much less complicated and can be accomplished by a laboratory technician without detailed robotics knowledge rather than by a robotics engineer (as has been necessary for more complicated systems previously). Where the attachment mechanism(s) and alignment mechanism(s) allow for more than one possible microplate position, the robot may be pre-programmed with each possible location such that the setup process only requires the robot to be provided with minimal information, e.g. to be informed which locations are in use. The positional information may be stored in a look-up table or similar such that the robot can simply look up the positions at which microplates are to be picked up and deposited.

Preferably the or each attachment mechanism is arranged to position a corresponding microplate storage device within the work envelope of the robotic arm. Similarly, preferably the or each alignment mechanism is arranged to position a corresponding instrument within the work envelope of the robotic arm. The work envelope of the robot is the locus of positions to which it can move a microplate, i.e. the positions at which it can pick up and/or deposit a microplate. A typical instrument will have a tray (typically referred to as a nest) in which it receives a microplate to be processed or analysed. It is this tray/nest that is preferably presented within the work envelope of the robot so that the robot can deposit a microplate in the nest for processing/analysis and retrieve a microplate from the nest after processing/analysis.

Plate storage devices may include one or more vertical stacks of microplates. In simple stack arrangements the robotic arm may simply retrieve a microplate from the top of a stack and/or deposit a microplate on top of a stack (e.g. retrieving sequentially from an input stack and depositing sequentially on an output stack). In other stack arrangements the robotic arm may select a microplate from one of several vertical positions within the stack (and can deposit back to any of those vertical positions). In more complex storage devices, the storage device may have internal mechanisms for selecting from the stack and may simply offer a selected microplate up to the robotic arm at a single well-defined position.

A system may include a single stack, with microplates being returned to the stack after processing. Alternatively, a system may include a plurality of stacks, e.g. an input stack and an output stack. Microplate storage devices may also include single microplate supports (i.e. a single microplate tray or nest) that can be used for temporary holding of a microplate, e.g. to speed up processing and make most efficient use of the processing/analysing machine, or for removing and replacing lids in cases where lidded microplates are used (the lids must be removed after a microplate is removed from a stack and before the microplate is provided to the machine, and the lid must be replaced after processing has completed and before the microplate is placed in a stack). A lid may be stored in a nest or other microplate storage device in much the same way as a microplate.

In some embodiments the robotic arm may have a vertical rotation axis around which the robotic arm can be rotated.

According to some preferred embodiments, the or each attachment mechanism and the or each alignment mechanism is arranged to position a centre of a microplate nest of each corresponding microplate storage device and instrument at an equal distance from a primary rotational axis of the robotic arm. With all microplate nests positioned at the same distance from the robot's primary axis, all nests are located on a circular arc centred on the axis and the robot can select a nest position merely by selecting a rotational angle around that axis and a vertical height. This reduces the number of degrees of freedom required of the robotic arm, allowing a much simpler and less expensive robotic arm to be used.

In particularly preferred embodiments the base has a substantially circular perimeter and the or each alignment mechanism is provided on the circular perimeter. Similarly, or alternatively, the or each storage device attachment mechanism may be provided on the circular perimeter. By providing these devices around a circular perimeter, the devices may be attached at any of a plurality of attachment points while defining the same positional relationship to the base. With the robotic arm mounted centrally on the circular base the robotic arm and the device nests will have the same positional relationship regardless of the particular attachment point selected. This is a particularly convenient arrangement in relation to microplate storage devices as it allows the setup to be varied according to a particular installation, e.g. according to the particular laboratory layout and according to the number of microplates, types of stacks and the presence or absence of lids. For example, in a particularly constrained space, it may be preferred to locate all microplate storage devices on one side of the base. In another example, where lids are not required it may be most efficient to locate the stacks as close as possible to the instrument, while in other cases where lids are used it may be more efficient to locate one or more individual nests close to the instrument so that a lid of the next microplate can be removed while the instrument is in use and the readied microplate thus located in the most efficient place next to the instrument for maximum microplate throughput. The interchangeability and ease of customisation of this system is highly beneficial, particularly in small scale bench top laboratory setups.

The instrument alignment mechanism is preferably brought into contact with a part of the instrument so as to locate the instrument relative to the alignment mechanism. As will be discussed further below, contact is typically made via one or more side walls of the instrument and/or via one or more feet of the instrument.

Unfortunately, the processing and analysis instrument bodies are not normally manufactured with the instrument's nest consistently positioned relative to the instrument's body (particularly its side walls and feet) to a high degree of precision. Instead the tolerances in the manufacturing and/or assembly processes result in small variations in those positional relationships which can be large enough that a robotic arm without enough degrees of freedom of movement will have difficulty in picking up and depositing microplates accurately (with a corresponding increase in the resulting handling errors and reduction in efficiency). This has not been a problem in previous systems where the individual system components are individually located on a bench as such systems already require a robotic arm with enough freedom of movement to accommodate such tolerances. Such prior art systems always involve a learning process during set up in which the robotic arm learns the exact position of each microplate pick-up and drop-off point.

Preferably the robotic arm has no more than four degrees of freedom of movement. More preferably the robotic arm has no more than three degrees of freedom of movement.

The robotic arm may have a first end which is a fixed end mounted to the base. This first end may be referred to as the proximal end. The robotic arm may have a second end which is a free end or operational end and which may be referred to as the distal end. Typically a microplate gripper is mounted on the distal end of the robotic arm to selectively grip and release microplates and/or lids. In some preferred embodiments the robotic arm has no more than two degrees of freedom of movement to move the distal end of the arm relative to the proximal end (i.e. to move the free end relative to the fixed end). The robotic arm may optionally have an additional degree of freedom to rotate a gripper mounted on the proximal end, thus having three degrees of freedom in total.

The robotic arm may have no more than two rotational pivots. Preferably one of said pivots is for rotating a gripper device mounted on a distal end of the arm.

In some preferred embodiments the robotic arm comprises a rigid bar pivotally mounted at its proximal end around a central axis and wherein the rigid bar comprises no further pivots between said proximal end and a distal end. Preferably a microplate gripper is pivotally mounted on the distal end of the rigid bar.

By reducing the number of degrees of freedom required of the robotic arm, the robotic arm is simplified and a less expensive arm can be used. As the robotic arm is the most expensive component of the microplate handling apparatus, simplifying the robotic arm can dramatically reduce the cost of such systems making them a viable option for much smaller scale projects and experiments.

Preferably all of the robotic arm's joints comprise DC stepper motors arranged to effect movement of said joints. The DC stepper motors are a low cost alternative to the expensive servomotors used in higher precision robotic arms for high precision. Larger robotic arms with larger numbers of degrees of freedom are typically operated with servo motors due to the higher level of control achievable with such motors. This is particularly important when several degrees of freedom are involved, and particularly where several pivots are involved as errors propagate through the system and can be amplified at each joint. By reducing the number of degrees of freedom of the robot, the level of precision required at each joint is less. It has been found in the present invention that when the robotic arm is reduced to only two degrees of freedom (plus an optional gripper rotator to make three degrees of freedom), DC servo motors can provide a sufficient level of control to locate microplates accurately in the systems described here.

As described above, the instrument manufacturing and assembly tolerances may result in variations in the position of the instrument's microplate nest relative to other parts of the instrument such as the side walls and feet. In some cases, these tolerances may result in a nest position that cannot be accommodated by robot movement, especially when the degrees of freedom of the robot are restricted. It is therefore preferred that the alignment mechanism is adjustable so as to permit adjustment of the relative position of the robotic arm relative to an instrument aligned on the alignment mechanism. This adjustment can be used to compensate for positional errors arising from the instrument's tolerances or indeed from other sources of small positional errors. This is achieved essentially by making the instrument movable (positionally adjustable) relative to the robotic arm.

The adjustment of the instrument alignment mechanism may be achieved in any suitable fashion. The type of adjustment that is required or that is optimal may depend on the exact construction of the system and the types of positional error that need to be compensated. However, in some preferred embodiments the alignment mechanism comprises at least one adjuster connecting the base to the alignment mechanism and arranged to be capable of adjusting the separation of the alignment mechanism and the base. Preferably the adjuster is arranged such that rotation of the adjuster changes the separation of the alignment mechanism and the base. The adjuster may be a threaded adjuster. Purely by way of example, a threaded adjuster may comprise a male threaded rod fixed to one part and mounted in a female threaded thumb wheel mounted to the other part such that rotation of the thumb wheel changes the separation of the two parts.

In the case of a circular base, the adjuster may be arranged substantially radially with respect to the base, so as to adjust the separation between parts in a radial direction. In order to prevent unwanted rotation of the two parts, one or more additional guide members may be provided with one part (preferably the alignment mechanism) slidably mounted on the guide members.

A single adjuster may be sufficient to accommodate any misalignment due to manufacturing tolerances. In the case of a rotational arm, it will be appreciated that a small amount of compensation may also be achieved in the circumferential direction (i.e. in the swinging direction of the distal end of the arm), by adjusting the angle to which the arm is rotated. The direction of adjustment of the adjuster is preferably arranged substantially perpendicular to this circumferential direction of adjustment for optimal compensation.

It will be appreciated that the above adjustment scheme allows compensation in two perpendicular directions, but does not permit any significant angular adjustment. The variations due to manufacturing tolerances may result in angular discrepancies, e.g. an instrument's nest may not be parallel with the side of the machine. If the alignment mechanism is designed to align against the side of the machine then the nest may be angled relative to the desired position as well as possibly being displaced from the desired position.

In some embodiments the alignment mechanism may comprise at least two adjusters, each connecting the base to the alignment mechanism and with the at least two adjusters being horizontally separated from each other so as to permit adjustment of the distance of the alignment mechanism from the base as well as the angle of the alignment mechanism relative to the base.

With two horizontally separated adjusters, simultaneous adjustment of both adjusters by the same amount and in the same direction will result in a purely translational adjustment, with no angular adjustment. However, by adjusting one adjuster by a different amount from the other adjuster, or by adjusting the two adjusters in opposite directions, the angle of the alignment mechanism relative to the base can be altered, thus allowing for compensation of any errors arising in the positioning of the instrument's nest relative to the optimal position for the robotic arm. The two adjusters may be two threaded adjusters such as thumb wheels as described above.

The instrument alignment mechanism may be formed from a single moulded part that is designed for attachment to the base and for contact with an instrument. There are several different types and manufacturers of instruments with which the microplate handling apparatus could be used and each instrument typically has its own shape and dimensions and therefore each needs its own particular positional relationship between its microplate nest and the robot to be defined. This alignment is broadly achieved by the shape and design of the alignment mechanism and how it is shaped to contact the instrument. As discussed above this may be achieved for example by forming one or more cups into which one or more of the instrument's feet can be located or by forming a corner (L-shaped part) designed to fit against and around a corner of the instrument. This corner to corner alignment (corner of alignment mechanism to corner of instrument) provides contact with two sides of the instrument and thus can define both position and angular orientation. As the instrument feet are typically circular, a foot cup will generally only provide a single positioning point of contact and therefore it is preferred to provide an additional such point of contact to define the position and angle relationship. This may be in the form of a second foot cup, a corner part as described above or simply any side wall contact part horizontally separated from the foot cup (this may be a simple bar to be brought into contact with the side wall. To align the instrument, the instrument foot is placed in the cup and the instrument may be pivoted about the foot until the side wall contacts the second contact point of the alignment mechanism.

While this structure may all be formed as a single part, the fact that there are many different instruments means that a different part is required for each instrument. Each part needs to be designed for a particular instrument as it defines the positional relationship for that particular instrument. Preferably therefore the alignment mechanism comprises a plurality of parts. One or more parts (such as the part that attaches to the base) may be common to several (or indeed all) instruments, while other parts may be interchanged according to the instrument that is to be used. In some preferred embodiments the instrument alignment mechanism comprises a first part attached to the base and a second part removably attached to the first part for alignment contact with an instrument. The second part may be a foot cup or corner contact as described above.

The second part is preferably firmly, but removably attached (i.e. not permanently fixed) to the first part, e.g. by means of slots/grooves or clips. For example the first part may be provided with one or more dovetail slots or similar and the second part may be provided with a correspondingly shaped rib or projection designed to slide into the slot(s) to be retained therein. Alternatively the two parts may be fastened by clips or by other removable fixing means such as screws or bolts.

In some embodiments the instrument alignment mechanism may further comprise a third part removably attached to the first part for alignment contact with the instrument. As mentioned above, the third part may be used to provide an additional contact point for better alignment with the instrument. Again, this is removably attached so as to be replaceable such that appropriately shaped third parts can be swapped in for different instruments. As above, the third part may comprise a simple contact point or contact bar, or it may comprise a corner shape or a foot cup.

The above arrangements allow a customer to use the microplate handling system with a number of different instruments. The different alignment parts can be moulded inexpensively, but with low enough tolerances to ensure good instrument alignment. The end user can therefore simply purchase the alignment parts that are required for the particular instruments that will be used. The microplate handling apparatus can also readily be used for other, e.g. new, instruments simply by acquiring the correct alignment parts and swapping them into the apparatus.

It may in some circumstances be sufficient simply to align the microplate handling apparatus with the instrument. If the equipment is sufficiently heavy and unlikely to be knocked, then further relative movement is unlikely. However, for added security, preferably some form of retaining means is provided to hold the instrument in position against the alignment mechanism and thereby prevent further relative movement between the instrument and the microplate handling apparatus. In some particularly preferred embodiments the instrument is held in place by a strap passed around at least a part (and possibly the whole) of the body of the instrument and also around at least a part (and possibly the whole) of the microplate handling apparatus. Preferably the microplate handling apparatus further comprises a slot formed in the instrument alignment part for receiving an instrument securing strap. The strap can be inserted into the slot, passed around the instrument and held securely, optionally employing some form of tightening mechanism such as a ratchet or tensioner to take up and slack and retain tension. The slot may be open at the top to allow the strap to be inserted from above. By forming the slot in the instrument alignment part the strap does not need to pass around the whole of the microplate handling apparatus and can be routed so as to avoid putting tension on other components.

Preferred embodiments of the invention will now be described, by way of example only, and with reference to the accompanying drawings in which:

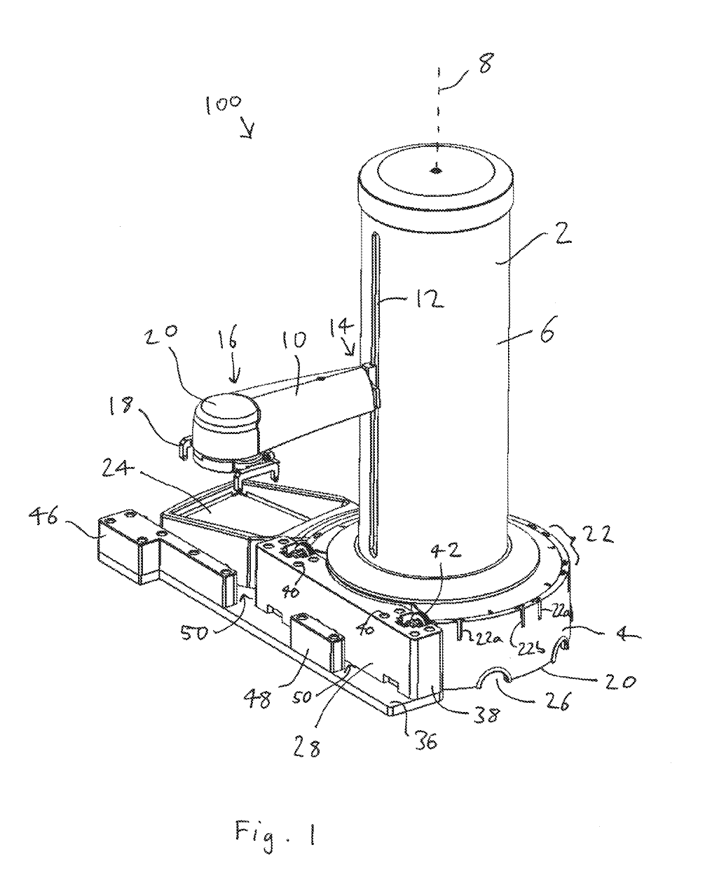

FIG. 1 shows an embodiment of a robotic arm with a microplate nest attached and an instrument alignment mechanism attached;

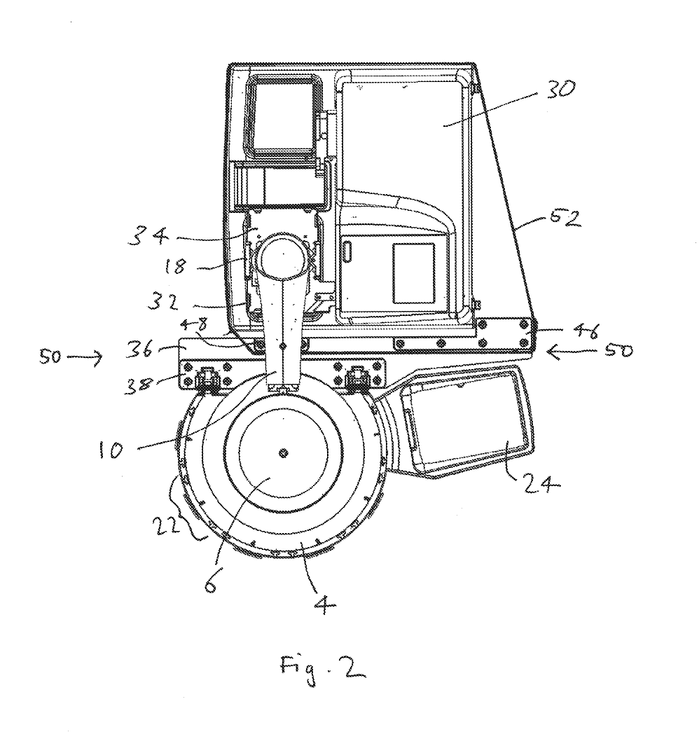

FIG. 2 shows a top view of a the robotic arm of FIG. 1 aligned with an instrument;

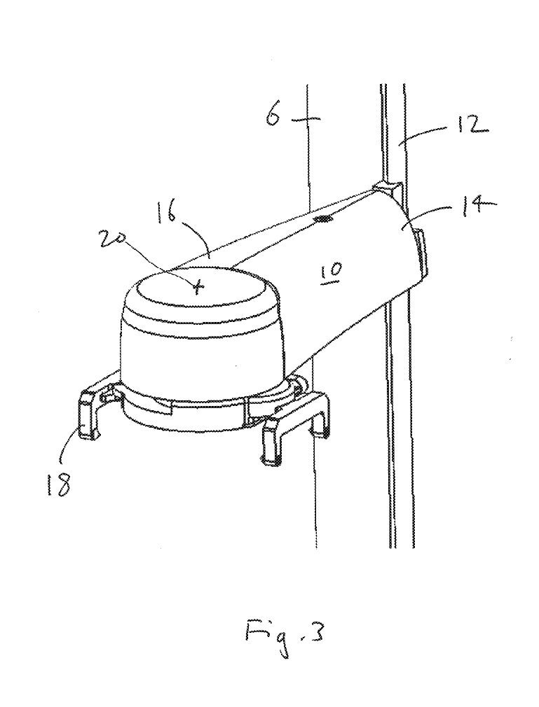

FIG. 3 shows a close-up of the robotic arm;

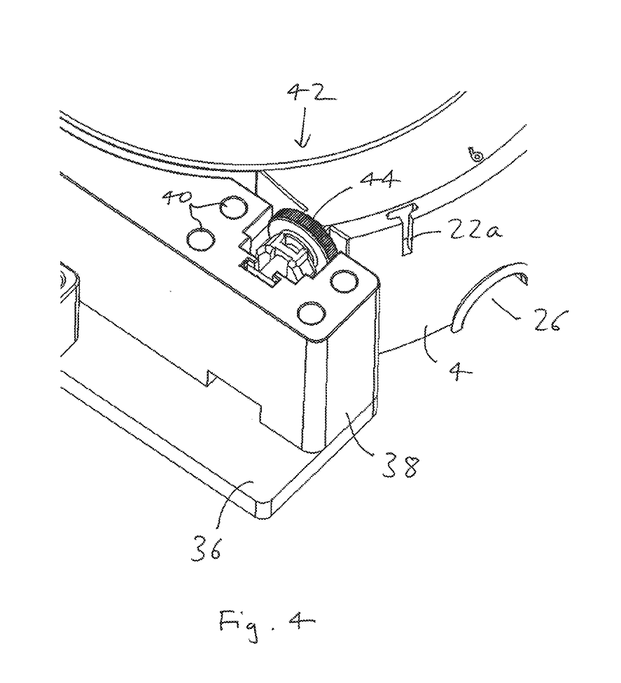

FIG. 4 shows a close-up of an adjustment mechanism; and

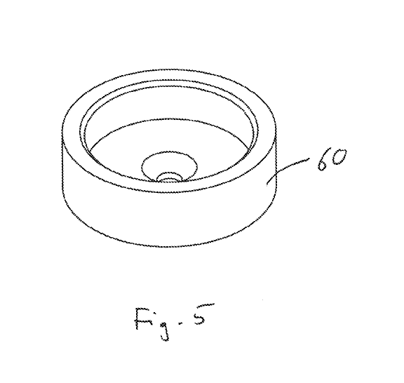

FIG. 5 shows an example of an instrument foot holder.

FIG. 1 shows a microplate handling apparatus 100. A robotic arm 2 is mounted on a base 4. The robotic arm 2 has a central vertical rotary shaft 6 which can rotate around its central axis 8 (this being the primary axis of rotation for the robotic arm 2). A rigid bar 10 extends horizontally from the central shaft 6. The rigid bar 10 is mounted to a slot 12 in the shaft 6 and is vertically movable relative to the shaft 6, i.e. vertically movable parallel to the rotation axis 8.

The proximal end 14 of the rigid bar 10 is mounted to the slot 12. The distal end 16 of the rigid bar 10 has a gripper 18 mounted thereto. The rigid bar 10 is shown in more detail in FIG. 3. The gripper 18 is rotationally mounted to the distal end 16 of the rigid bar 10 such that it can rotate around a secondary rotation axis 20 (although it will be appreciated that in some embodiments the gripper 18 need not be mounted in a rotary fashion and could therefore be fixed in a non-rotary manner to the distal end 16 of the rigid bar 10). The gripper device 18 is typically used to grip the sides of a microplate (or the lid of a microplate when the lid is to be removed from the microplate) between two gripping claws. The gripping claws can be moved together to grip and hold or moved further apart to release.

Although not shown in the figures, each of the robotic arm's joints (e.g. the joint where the central shaft 6 pivots on the base 4, the joint where the rigid bar 10 slides up and down the central shaft 6 and the joint where the gripper 18 rotates relative to the rigid bar 10) are driven by DC stepper motors. These are much less expensive than the servo motors used in more complex robotic arms, but with the simplified structure of this apparatus, the DC stepper motors are sufficiently accurate, thus greatly reducing the overall cost of the apparatus 100.

The robotic arm 2 has three degrees of freedom, the first being rotation about the primary rotation axis 8 of the central shaft, the second being translation of the rigid bar 10 vertically up and down the shaft 6 in slot 12, and the third being rotation of the gripper device 18 on the distal end 16 of rigid bar 10.

The robotic arm 2 is mounted to a base 4 that provides a stable support structure and is the central structure to which all other bits of equipment are connected. The base 4 is generally circular in this embodiment, having a circular perimeter 20, although it will be appreciated that other shapes may be used. A benefit of the circular design is that the robotic arm 2 can be mounted concentrically with the circular base so that other pieces of equipment attached to the base 4 will have a definite and consistent relationship with the work envelope of the robotic arm 2 regardless of their angular position of attachment to the base 4. The work envelope of the robotic arm 2 may be defined as the locus of positions at which the gripper 18 can pick up or deposit a microplate. With the arrangement described here, the work envelope is a cylinder, centred on the primary rotation axis 8 with a radius equal to the distance of the centre of the gripper device 18 from the primary rotation axis 8 and with a vertical extent defined by the vertical range of motion of the rigid bar 10 in the slot 12.

Around the perimeter 20 of the base 4, there are several (six in this embodiment) attachment points (or attachment mechanisms) 22 at which other pieces of equipment may be attached. As an example, a microplate storage nest 24 is shown attached to one of the attachment mechanisms 22 in FIG. 1. The nest 24 is a simple type of storage device capable of storing either a single microplate or a stack of microplates simply stacked one on top of the other. Such nests 24 may be used for temporary storage of a single microplate or lid, e.g. for a lid removal or lid storage operation, or just to store a plate close to the next piece of processing or analysis equipment. Alternatively, a nest 24 may be used as an input stack or an output stack, the plates in an input stack being processed sequentially from top to bottom and stored sequentially from bottom to top to form an output stack. Several such nests 24 may be attached to the base 4 at the various attachment points 22 as required. In a typical simple installation only two or three attachment points 22 may be used, but providing six allows for flexibility in terms of selecting positions that are convenient for a particular laboratory setup (e.g. where the installation space is small or constrained in shape), as well as the flexibility to use a larger number of stations (e.g. two or more input stacks and two or more output stacks, and/or temporary storage points).

It will be appreciated that more complicated storage equipment may be attached instead of simple nests 24. For example plate storage systems that have their own internal microplate picking system can be attached so as to serve up a chosen microplate within the work envelope of the robotic arm 2.

Each attachment point 22 in this embodiment comprises two slots 22a, 22b, each having a T-shaped cross-section and being open at the top. A piece of equipment may be attached by being provided with appropriately sized and positioned T-shaped projections that can be slotted in to the twos lots 22a, 22b from above. As can be seen in FIG. 1, the nest 24 is also curved at its connecting end so as to mate against the circular perimeter 20 of the base 4. This provides a secure and solid connection such that the position of the microplate(s) held in the nest 24 is well-defined with respect to the robotic arm 2.

Around the perimeter of the base 4, a number of cable channels 26 are formed to allow for power and/or communications leads to reach the robotic arm 2 and associated control circuitry. In this embodiment these are conveniently arranged so that there is one channel 26 for each attachment point 22, centrally located with respect thereto. The provision of a number of such channels 26 again allows flexibility in the setup of the equipment so that it can readily be adapted for a particular laboratory.

An instrument alignment mechanism 28 is also connected to base 4. The instrument alignment mechanism 28 is shaped so as to receive a microplate processing instrument 30 (which can be seen in FIG. 2, but not in FIG. 1) in such a way that the positional relationship between the instrument 30 and the robotic arm 2 is well-defined, i.e. such that when the instrument 30 and the instrument alignment mechanism 28 together define a certain positional relationship. When duly engaged, a microplate nest 32 of the instrument 30 is positioned within the work envelope of the robotic arm. This means that the centre of the nest 32 is aligned with the centre of the gripping device 18 sufficiently well that the robotic arm 2 can reliably and accurately pick up a microplate 34 from the nest 32 and deposit a microplate 34 in the nest 32. It will be appreciated that there is some tolerance in these actions in that the gripper can hold a microplate 34 slightly off centre and the nest 32 can allow for a slight disparity between the centre position of the gripper 18 and the centre position of the nest 32, e.g. by providing slightly sloped sides that guide the microplate 34 into the nest 32. However, the aim is to minimise such misalignments so as to improve the reliability and consistency of operation with reduced chances of misplacing or dropping a microplate 34 (with associated spillage and/or disruption to the processing workflow).

While the base 4 has a substantially circular perimeter 20, the instrument alignment mechanism 28 is attached to a flattened part of the perimeter of the base 4. In other words the base 4 has a flat edge forming a chord across the generally circular shape of the base 4. The embodiment shown in the figures is only designed for a single instrument alignment mechanism 28 to be attached to the base 4. This is preferred for simple setups where a single complex processing or analysis machine is required. However, it will be appreciated that where more than one such machine is required, it may be possible to attach a further instrument alignment mechanism to one or more of the attachment points 22, or to form an additional flat section (chord) on the base 4 for a second instrument alignment mechanism 28.

The instrument alignment mechanism 28 is formed from a number of parts and can be readily adapted to a number of different instruments 30. A flat base part 36 is common to all configurations and provides an attachment surface for various other parts that are specific to each configuration. In this embodiment a first part 38 is attached to the base part 36 and provides a connection mechanism for connecting the instrument alignment mechanism 28 to the base 4. The first part 38 may be attached to the base part 36 in any suitable way, but for convenience and ease of assembly and adaption, the first part 38 is preferably attached to the base part 36 by means of removable fixing means such as screws 40. The first part 38 has two adjuster mechanisms 42 each of which connects the first part 38 to the base 4 in an adjustable manner. Each adjuster 42 is a thumb wheel in this embodiment. One adjuster 42 is shown in more detail in FIG. 4. Each adjuster 42 has a thumb wheel 44 that is held captive in the first part 38 such that it can rotate with respect to the first part 38, but cannot move axially with respect to it. The thumb wheel 44 has a central axial hole which is internally threaded and receives an externally threaded bolt (not visible) which is fixedly attached to the base 4 and projects towards and partially into the first part 38. As the thumb wheel 44 is rotated, the mated thread portions of the wheel 44 and the bolt cause axial displacement of the wheel 44 along the rod and thus adjust the separation distance of the base 4 and the first part 38.

As two adjusters 42 are provided, spaced apart from one another and connected to the base 4 at different points, both the spacing and orientation of the instrument alignment mechanism can be adjusted relative to the base 4. For example by adjusting both adjusters 42 in the same direction and by the same amount, the instrument alignment mechanism 28 can be moved towards or away from the base 4 (in a generally radial direction), while adjustment of the two adjusters 42 in opposite directions by equal amounts will rotate the instrument alignment mechanism 28 relative to the base 4. Thus by careful adjustment of both adjusters 42 the instrument alignment mechanism 28 (and thus an instrument 30 that is aligned with the instrument alignment mechanism 28) can be adjusted such that the nest 32 of the instrument 30 is accurately placed in the work envelope of the robotic arm 2 for optimal operation (i.e. with minimal risk of microplate pick-up or placement errors).

In this embodiment the base part 36 is L-shaped so that it forms a corner between the two straight sections of the “L”. The second part 46 of the instrument alignment mechanism 28 is an extension of the L-shape of the base part 36 and is attached thereto by screws 40. The corner shape is useful for ensuring correct placement and alignment of an instrument 30 against the alignment mechanism 28 by settling a corner of the instrument 30 into the corner of the L-shape. As the L-shape contacts two sides of the instrument 30, its relative orientation is defined as well its relative position. In some cases, if the instrument 30 has a suitable corner shape close to the bench, the second part 46 may not be necessary (the corner shape of the base part 36 serving the alignment function). However, in other embodiments the base part 36 may not have an L-shape or it may not extend high enough to contact the instrument side walls (e.g. if the instrument is raised off the bench on feet). For best alignment, the L-shape could extend a significant distance in each direction so as to provide significant contact between the second part 46 and the instrument walls. However, to keep the size of the second part 46 small, the L-shape may be asymmetrical, only providing enough surface to ensure accurate positioning without ensuring accurate orientation. To ensure accurate orientation, a third part 48 is then provided to contact the instrument side wall closest to the base 4 at another position along the base part 36. Again the third part 48 may be fixed to the base 36 by screws 40 or similar.

It can be seen that this design allows significant flexibility for aligning a number of different instruments with the robotic arm 2. Each instrument has a nest 32 that needs to be aligned with the robotic arm 2 so that it is placed accurately within the work envelope of the robot (thus avoiding the need for more degrees of freedom in the robot). Thus each instrument needs a suitably formed instrument alignment mechanism 28. This can be formed using inexpensively molded plastic parts that are dimensioned so as to engage the instrument 30 at suitable corners and/or walls to place its nest 32 radially in line with the robotic arm 2 (i.e. radially in line with the rigid bar 10). The alignment mechanism also ensures a coarse positional alignment of the nest 32 along the radial direction so that the centre of the nest 32 aligns with the centre of the gripper 18 on the distal end 16 of the rigid bar 10. Fine adjustment to provide the optimal spatial alignment of the nest 32 with the gripper 18 is achieved by means of the adjusters 42.

It will be appreciated that each configuration of the various parts 36, 38, 46, 48 of the alignment mechanism 28 may be re-usable for several different instruments 30. For example the first part 36 is the most complicated to mold and is preferably re-usable for all instruments 30. Of the simpler shaped (and easier to mold) parts, these may be designed specifically for a certain instrument 30, but they are preferably also re-usable for multiple instruments where possible. For example the base part 36 may be a suitable basic mounting platform for several instruments 30. Specific versions of the second part 46 will most likely be required for each instrument 30 as this part locates the instrument corner. The third part 48 can likely apply to several different instruments as it merely provides additional bracing for correct orientation.

In some embodiments, instead of locating a corner of an instrument 30 (e.g. in cases where an instrument may not have a well-defined corner), location and orientation can instead be provided by cups arranged to locate and hold the instrument's feet. An example of such a cup 60 is shown in FIG. 5. For such embodiments, a dedicated base part 36 may be provided for the instrument 30 with suitably positioned mounting points for the foot cups 60.

Overall, the instrument-specific parts required for proper alignment are minimal and can be manufactured inexpensively, allowing this system to be used on a large range of instruments 30 at minimal expense to the end user.

With the arrangement described above, it will be appreciated that an instrument 30 and the robotic arm 2 can be positioned reliably with respect to one another without fixing anything to a laboratory bench and without having to go through a complex training or programming exercise to teach the robotic arm 2 where to pick up and place microplates in the various stores (e.g. input and output stacks) and instruments 30. Once in instrument 30 is positioned with the correct instrument alignment mechanism 28 and adjusted via adjusters 42, the positions are unlikely to change providing the instrument 30 and the base 4 are not knocked or vibrated out of alignment for some reason. However, if such misalignment is a significant risk then for additional security a strap may be used to hold the instrument 30 to the alignment mechanism 28. For this purpose a slot 50 is formed in the instrument alignment mechanism, passing behind at least one of the second and third parts 46, 48 (or both if they are both in use). A strap 52 (shown in FIG. 2) can be dropped into the slot 50, passed around the instrument 30 and brought into tension to hold the instrument 30 against the alignment mechanism 28. Any accidental knocks or vibrations should then not affect the relative position and alignment of the instrument 30 and the robotic arm 2.

1. A microplate handling apparatus comprising:
a base; and
a robotic arm mounted on the base;
wherein the base has at least one attachment mechanism for attaching a microplate storage device to the base; and
wherein the base has at least one instrument alignment mechanism for defining a positional relationship between the robotic arm and an instrument

2. A microplate handling apparatus as claimed in claim 1, wherein the or each attachment mechanism is arranged to position a corresponding microplate storage device within the work envelope of the robotic arm.

3. A microplate handling apparatus as claimed in claim 1, wherein the or each alignment mechanism is arranged to position a corresponding instrument within the work envelope of the robotic arm.

4. A microplate handling apparatus as claimed in claim 1, wherein the or each attachment mechanism and the or each alignment mechanism is arranged to position a centre of a microplate nest of each corresponding microplate storage device and instrument at an equal distance from a primary rotational axis of the robotic arm.

5. A microplate handling apparatus as claimed in claim 1, wherein the base has a substantially circular perimeter and wherein the or each alignment mechanism is provided on the circular perimeter.

6. A microplate handling apparatus as claimed in claim 1, wherein the robotic arm has no more than 3 degrees of freedom.

7. A microplate handling apparatus as claimed in claim 6, wherein the robotic arm has no more than two rotational pivots.

8. A microplate handling apparatus as claimed in claim 7, wherein one of said pivots is for rotating a gripper device on a distal end of the arm.

9. A microplate handling apparatus as claimed in claim 6, wherein the robotic arm comprises a rigid bar pivotally mounted at its proximal end around a central axis and wherein the rigid bar comprises no further pivots between said proximal end and a distal end.

10. A microplate handling apparatus as claimed in claim 9, wherein a microplate gripper is pivotally mounted on the distal end of the rigid bar.

11. A microplate handling apparatus as claimed in claim 1, wherein all robot joints comprise DC stepper motors arranged to effect movement of said joints.

12. A microplate handling apparatus as claimed in claim 1, wherein the alignment mechanism is adjustable so as to permit adjustment of the relative position of the robotic arm relative to an instrument aligned on the alignment mechanism.

13. A microplate handling apparatus as claimed in claim 12, wherein the alignment mechanism comprises at least one adjuster connecting the base to the alignment mechanism such that rotation of the adjuster adjusts the separation of the alignment mechanism and the base.

14. A microplate handling apparatus as claimed in claim 13, wherein the alignment mechanism comprises at least two adjusters, each connecting the base to the alignment mechanism and the at least two adjusters being horizontally separated from each other so as to permit adjustment of the distance of the alignment mechanism from the base as well as the angle of the alignment mechanism relative to the base.

15. A microplate handling apparatus as claimed in claim 1, wherein the instrument alignment mechanism comprises a first part attached to the base and a second part removably attached to the first part for alignment contact with an instrument.

16. A microplate handling apparatus as claimed in claim 15, wherein the instrument alignment mechanism further comprises a third part removably attached to the first part for alignment contact with the instrument.

17. A microplate handling apparatus as claimed in claim 1, further comprising a slot formed in the instrument alignment part for receiving an instrument securing strap.
